(19) United States
(12) Patent Application Publication
(10) Pub. No.: US 2005/0094032 A1
(43) Pub. Date: May 5, 2005

(54) System and method for selectively displaying scrolling news ticker on TV

(76) Inventor: John L. Rogitz, San Diego, CA (US)

Correspondence Address: John L. Rogitz, Esq.;ROGITZ & ASSOCIATES, Suite 3120, 750 "B" Street, San Diego, CA, 92101, US

(21) Appl. No.: 10/696,141

(22) Filed: Oct. 29, 2003

(51) Int. Cl. H04N 5/445

(52) U.S. Cl. 348/553; 348/564

(57) ABSTRACT

A TV viewer can rid himself of annoying scrolling messages at the bottom of a newscast simply by manipulating a button on a remote control, so that he can remain blissfully undistracted as he watches the news while, e.g., sipping a beer.

### FIELD OF THE INVENTION

The present invention relates generally to televisions.

### BACKGROUND

Televised newscasts now ubiquitously display, near the bottom of the image, an alpha-numeric news ticker that is superimposed on the underlying image and that displays messages which scroll across the display. The news ticker presents news snippets in addition to the main video content being displayed, evidently with the notion that the broadcaster has so much important news to report, and that the news is so urgent, that multiple stories must be inflicted on the viewer simultaneously, even if the video content is an Oprahfied report on an individual's otherwise uninteresting feelings about an irrelevant subject and the content scrolling below is a report of the rise of the price of ragweed in Timbuktu. In other words, most of the scrolling content is distracting trivia that the present inventor, for one, would be thrilled to be rid of.

### SUMMARY OF THE INVENTION

A TV system includes a receiver including a TV tuner, a TV display configured for receiving at least one televised newscast from the tuner and in response thereto displaying a video portion and an alpha-numeric ticker scrolling across the video portion, and a control device manipulable by a viewer of the TV display to remove the alpha-numeric ticker from view.

The TV tuner can be a digital tuner. A digital processing device can be provided for receiving a viewer-generated suppress signal and in response removing the alpha-numeric ticker from view on the display. The processing device may suppress the alpha-numeric ticker in a video stream. The control device can be a human-manipulable remote control device.

In another aspect, a method for operating a TV system including a receiver and a TV tuner includes receiving a newscast, identifying an action/video portion in the newscast, identifying a scrolling portion in the newscast, and in response to a user-generated signal, preventing the scrolling portion from being displayed on a TV monitor with the action/video portion of the newscast.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of one non-limiting exemplary embodiment of the present TV system;

FIG. 2 is a schematic diagram of the display, showing the video portion and the scrolling ticker; and

FIG. 3 is a flow chart of exemplary logic.

### DETAILED DESCRIPTION OF THE PREFERRED EMBODIMENT

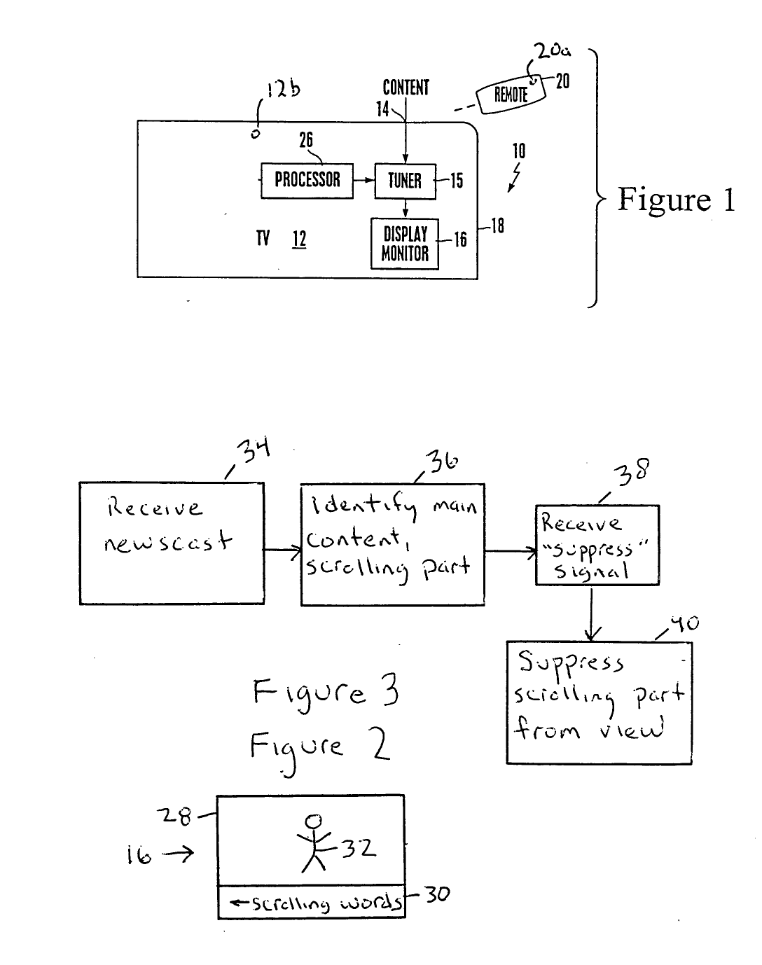

Referring initially to FIG. 1, a system is shown, generally designated 10. As shown, the system 10 includes a TV 12 potentially having one or more human-manipulable controls 12b. The TV 12 conventionally receives televised content at a content receiver 14 (e.g., an antenna, satellite dish, set-top box, etc.), with a channel being selectable by means of a conventional tuner 15 for display of the content on a monitor 16.

While the embodiment of FIG. 1 shows a TV 12 with a single housing that includes a microprocessor, it is to be understood that the term “television system” encompasses any apparatus that has a television tuner and the below-described capability in a single housing or in separate housings that cooperate together. For instance, the term “TV system” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds the conventional television tuner 15 which receives the TV signals. One or more viewer input devices, such as but not limited to a wireless TV remote control device 20 having one or more controls/buttons 20a, can be used to input the below-described scrolling ticker suppress signal to the processor discussed below.

More particularly, a microprocessor 26 communicates with the TV circuitry for presenting or not an alpha-numeric scrolling portion of a newscast having a video portion shown on the display 12 in accordance with the disclosure below. As intimated above, the microprocessor 26 can be located in the housing 18 or it can be disposed elsewhere, such as in a set-top box, remote control device, or other component. In any case, the microprocessor 26 executes the logic set forth herein.

It is to be understood that the microprocessors disclosed herein control the respective TV tuners in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g.,, the present microprocessor as a series of computer-executable instructions. In addition to residing on hard disk drives, these instructions may reside, for example, in RAM of the appropriate computer, or the instructions may be stored on magnetic tape, electronic read-only memory, or other appropriate data storage device.

FIG. 2 shows that the display 16 conventionally shows both an action/video portion 28 of newscast content, and a scrolling ticker 30 that is superimposed or otherwise presented with (usually near the bottom of the monitor 16) the action/video portion 28 and that displays alpha-numeric news messages which scroll across the display 16, in the case shown in FIG. 2, from right to left. The action/video portion 28 of newscast content can include, e.g., images 32 of moving figures or other objects. The purpose of the present invention is to allow a viewer to selectively rid himself of the nuisance of the scrolling ticker 30.

Accordingly, FIG. 3 shows that at block 34, a newscast is received at the content receiver 14 and, if the tuner 15 is so configured, displayed on the monitor 16. At block 36 the main content, i.e., the action/video portion 28 of newscast content shown in FIG. 2, is identified as well as the scrolling ticker 30 content. This can be done by receiving information in the received stream itself that indicates which portions of the data stream belong to the action/video portion 28 and which belong to the scrolling ticker 30. Or, the identification can be made by logical recognition. For instance, the processor 26 can assume that anything displayed with or superimposed on a video feed near the bottom edge of the displayed image and that has a constant motion in one direction (as indicated by, e.g., motion vectors), and/or that includes alpha-numeric characters as detected by character recognition principles known in the art, is the scrolling ticker 30.

At block 38, the viewer may elect to relieve himself of the distraction of the scrolling ticker 30. He can do this by appropriately manipulating one or more of the controls 12b and/or 20a to generate a suppress signal. In response, at block 40 the processor 26 obligingly suppresses or otherwise removes from view the scrolling ticker 30 so that it cannot be seen on the monitor 16. Either the image of the scrolling ticker 30 may be suppressed, or the data in the newscast video stream representing the scrolling ticker 30 may be removed from the stream, or other techniques employed to prevent the hideously scrolling ticker 30 from being presented to the viewer. The control can be toggled to turn back on the ticker 30.

While the particular SYSTEM AND METHOD FOR SELECTIVELY DISPLAYING SCROLLING NEWS TICKER ON TV as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

1. A TV system, comprising:
a receiver including a TV tuner;
a TV display configured for receiving at least one televised newscast from the tuner and in response thereto displaying a video portion and an alpha-numeric portion scrolling across the video portion; and
at least one control device manipulable by a viewer of the TV display to remove the alpha-numeric portion from view.

2. The TV system of claim 1, wherein the TV tuner is a digital tuner.

3. The TV system of claim 1, further comprising a digital processing device receiving a viewer-generated suppress signal and in response removing the alpha-numeric portion from view on the display.

4. The TV system of claim 3, wherein the processing device suppresses the alpha-numeric portion in a video stream.

5. The system of claim 1, wherein the control device is a human-manipulable remote control device.

6. A method for operating a TV system including a receiver and a TV tuner, comprising:
receiving a newscast;
identifying an action/video portion in the newscast;
identifying a scrolling portion in the newscast; and
in response to a user-generated signal, preventing the scrolling portion from being displayed on a TV monitor with the action/video portion of the newscast.

7. The method of claim 6, wherein the identifying act is done based at least in part on information in the newscast.

8. The method of claim 6, wherein the identifying act is done based at least in part on logical recognition of elements in the newscast.
